(19) United States
(12) Patent Application Publication
(10) Pub. No.: US 2025/0350935 A1
(43) Pub. Date: Nov. 13, 2025

(54) SECURE TRANSMISSION OF COMMANDS TO RESTRICTED DEVICES

(71) Applicant: LENOVO (SINGAPORE) PTE LIMITED, SINGAPORE (SG)

(72) Inventors: Andreas KUNZ, Ladenburg (DE); Sheeba Backia Mary BASKARAN, Friedrichsdorf (DE)

(21) Appl. No.: 18/660,853

(22) Filed: May 10, 2024

(51) Int. Cl. H04W 12/041; H04L 5/00; H04W 12/0431

(52) U.S. Cl. CPC H04W 12/041; H04L 5/0053; H04W 12/0431

(57) ABSTRACT

Various aspects of the present disclosure relate to providing secure communications with restricted devices, such as ambient-powered Internet of Things (IoT) devices. For example, an IoT device and associated network function may employ signature generation by utilizing a shared secret parameter, such as a private device identity (e.g., a unique string or random number), to ensure secure communications, such as when the network function sends commands to the IoT device.

### TECHNICAL FIELD

The present disclosure relates to wireless communications, and more specifically to secure transmissions of commands to restricted devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Ambient power-enabled devices, such as ambient power-enabled Internet of Things (IoT) devices, or AIoT devices, include battery-less devices that have limited energy storage capabilities (e.g., they store a limited amount of energy using capacitors) or other capability restrictions. These restricted devices may store energy by harvesting energy from the environment of the IoT device, such as via radio waves, light, heat, motion, and other energy/power sources available to the IoT device. Example AIoT devices and other restricted devices include location tags or stickers, such as tags attached to objects that enable a network server to track locations of the objects.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support secure communications between an AIoT controller or other network function and an AIoT device or multiple AIoT devices.

Some implementations of the method and apparatuses described herein may further include a UE, comprising at least one memory and at least one processor coupled with the at least one memory and configured to cause the UE to receive a command request message that comprises a nonce, a command, and a signature, generate a security key based on a secret parameter and the nonce, generate a signature using the generated security key and the command as input parameters, compare the signature of the command request message to the generated signature, and perform an action in response to the command of the command request message when the comparison determines a match of the generated signature to the signature of the command request message.

In some implementations of the method and apparatuses described herein, the command comprises command parameters and the UE performs the action by executing the command parameters.

In some implementations of the method and apparatuses described herein, the at least one processor is configured to cause the UE to generate the signature using a hash function and an encryption function.

In some implementations of the method and apparatuses described herein, the at least one processor is further configured to cause the UE to transmit a response message to a network function after performing the action.

In some implementations of the method and apparatuses described herein, the UE is an AIoT device.

In some implementations of the method and apparatuses described herein, the command comprises a control, read, or write operation to be performed by the UE, and wherein the UE performs the action by performing the control, read, or write operation.

In some implementations of the method and apparatuses described herein, the command comprises an enable or disable operation to be performed by the UE, and wherein the UE performs the action by performing the enable or disable operation.

Some implementations of the method and apparatuses described herein may further include a processor for wireless communication, comprising at least one controller coupled with at least one memory and configured to cause the processor to receive a command request message that comprises a nonce, a command, and a signature, generate a security key based on a secret parameter and the nonce, generate a signature using the generated security key and the command as input parameters, compare the signature of the command request message to the generated signature, and perform an action in response to the command of the command request message when the comparison determines a match of the generated signature to the signature of the command request message.

In some implementations of the method and apparatuses described herein, the command comprises command parameters and the processor performs the action by executing the command parameters.

In some implementations of the method and apparatuses described herein, the at least one controller is configured to cause the processor to generate the signature using a hash function and an encryption function.

In some implementations of the method and apparatuses described herein, the at least one controller is further configured to cause the processor to transmit a response message to a network function after performing the action.

In some implementations of the method and apparatuses described herein, the processor is an AIoT device.

In some implementations of the method and apparatuses described herein, the command comprises a control, read, or write operation to be performed by the processor; and wherein the processor performs the action by performing the control, read, or write operation.

In some implementations of the method and apparatuses described herein, the command comprises an enable or disable operation to be performed by the processor; and wherein the processor performs the action by performing the enable or disable operation.

Some implementations of the method and apparatuses described herein may further include a method performed by a UE, the method comprising receiving a command request message that comprises a nonce, a command, and a signature, generating a security key based on a secret parameter and the nonce, generating a signature using the generated security key and the command as input parameters, comparing the signature of the command request message to the generated signature, and performing an action in response to the command of the command request message when the comparison determines a match of the generated signature to the signature of the command request message.

In some implementations of the method and apparatuses described herein, the command comprises command parameters and the UE performs the action by executing the command parameters.

In some implementations of the method and apparatuses described herein, the UE generates the signature using a hash function and an encryption function.

In some implementations of the method and apparatuses described herein, the method further comprises transmitting a response message to a network function after performing the action.

Some implementations of the method and apparatuses described herein may further include a network function, comprising at least one memory, and at least one processor coupled with the at least one memory and configured to cause the network function to transmit a command request message to an AIoT device that comprises a nonce, a command represented by command parameters, and a signature and receive a response message from the AIoT device that comprises an acknowledgement of the command request message.

In some implementations of the method and apparatuses described herein, the at least one processor is further configured to generate a security key for the signature, and encrypt the command parameters using the generated security key.

### BRIEF DESCRIPTION OF THE DRAWINGS

FIG. 1 illustrates an example of a wireless communications system in accordance with aspects of the present disclosure.

FIG. 2 illustrates an example of messaging between an AIoT controller and an ambient-powered IoT device in accordance with aspects of the present disclosure.

FIG. 3 illustrates an example messaging flow between an AIoT controller and an IoT device in accordance with aspects of the present disclosure.

FIGS. 4A-4B illustrate example key generation representations in accordance with aspects of the present disclosure.

FIGS. 5A-5C illustrate example signature generation representations in accordance with aspects of the present disclosure.

FIG. 6 illustrates an example of a user equipment (UE) in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by a NE in accordance with aspects of the present disclosure.

### DETAILED DESCRIPTION

AIoT devices may have a low complexity (e.g., low power consumption and few capabilities) to ensure a long life (e.g., 10 plus years) and usefulness. Unlike other IoT devices, such as those defined by 3GPP (3^{rd} Generation Partnership Project), ambient power-enabled devices may not include a USIM (universal subscriber identity module), and thus may lack components that can apply security to communications to/from the devices. Example ambient power-enabled IoT devices may include tags that track items across a supply chain or e-commerce platform.

Lacking a USIM or other similar component, these IoT devices cannot employ typical security protocols or features, such as protocols that determine whether a message received by an IoT device is a message from a legitimate or known source (e.g., a controller or network function associated with the IoT device) or from a nefarious or unknown source (e.g., an attacker attempting to control or disable the device).

For example, an AIoT device may receive command messages, from legitimate sources, which command the AIoT device to perform a disable operation (e.g., stop transmitting RF signals). However, the AIoT device does not have capabilities for discerning between legitimate command messages and spoofed command messages. Thus, scenarios may arise where the AIoT device performs a disable operation in response to receiving a spoofed command message. In such scenarios, the AIoT device may not respond to a network function, or other legitimate sources, leading to a Denial of Service (DOS), among other drawbacks.

Thus, ambient power-enabled IoT devices may employ techniques that facilitate such restricted devices to determine whether received command messages are secure and/or from known or trusted sources (e.g., an AIoT controller or other network function associated with multiple AIoT devices). For example, the AIoT device and associated network function (e.g., an AIoT controller or server) may employ signature generation by utilizing a shared secret parameter, such as a private device identity (e.g., a unique string or random number), to ensure secure communications.

Using the generated signatures, the AIoT device and associated network function can use simple, low complexity solutions to ensure command messages and other communications are between known or trusted entities, without relying on complex or energy-inefficient security mechanisms, among other benefits.

Aspects of the present disclosure are described in the context of a wireless communications system.

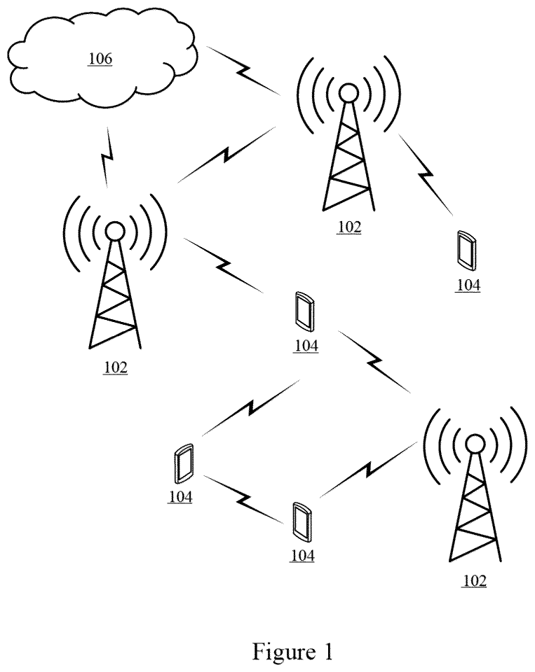

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHZ), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

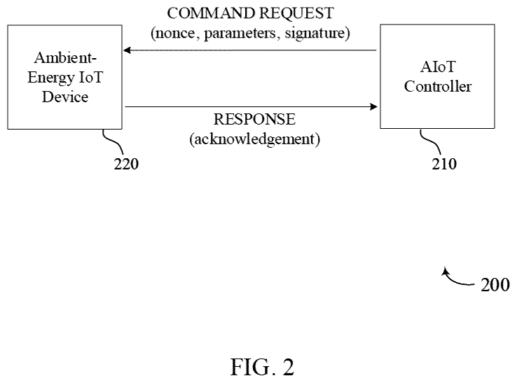

As described herein, the technology can utilize secret parameters to ensure secure messaging between an IoT device (or devices), such as a restricted device, and an IoT server, such as an AIoT controller. FIG. 2 illustrates an example of messaging 200 between an AIoT controller 210 and an ambient-powered IoT device 220 in accordance with aspects of the present disclosure.

The AIoT controller 210 sends a command request message to the IoT device 220. For example, the command request message can include a command, and associated command parameters, which causes the IoT device 220 to perform an action or operation. The command request message may include a nonce, the command (and/or command parameters), and a signature.

In some cases, the command may be associate with an inventory request, such as when the IoT device 220 is a tag on an object (e.g., a television). The command request message may request information about the associated object, such as an electronic product code (EPC) for the object.

In some cases, the command may include a request to the IoT device 220 to perform a read operation, a write operation, a control operation, an enable operation, and/or a disable operation. For example, the command may include command parameters that instruct the IoT device to stop transmitting RF signals for a certain time period.

In other cases, the command may be an application specific command and/or device specific command, such as a command that instructs the IoT device 220 to perform a specific function or action. For example, the command may include command parameters that cause the IoT device to perform a simple measurement or data capture (e.g., measure a surrounding temperature), and transmit the data back to the AIoT controller 210.

The IoT device 220, in response to the request message, can perform a security operation, as described herein, and transmit a response message back to the AIoT controller 210 that indicates an acknowledgement of the received message and/or a result of a requested command.

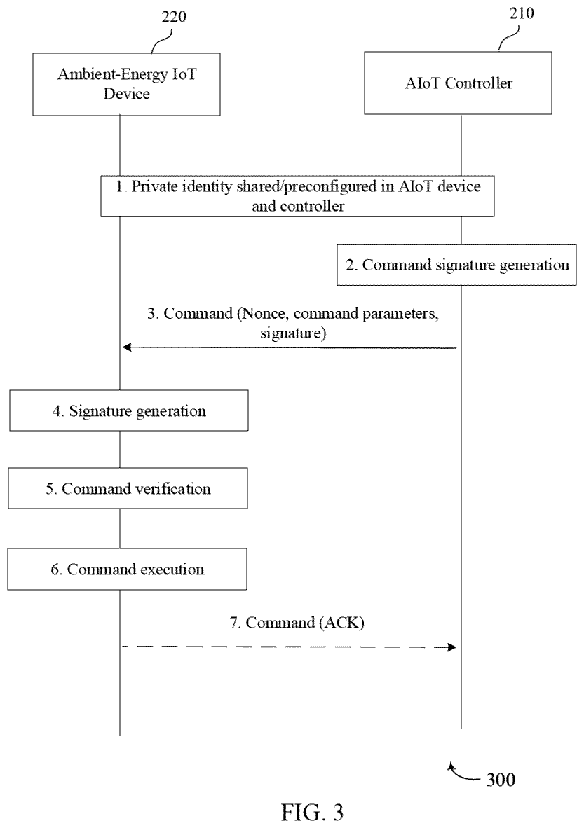

FIG. 3 illustrates an example messaging flow between the AIoT controller 210 and the IoT device 220 in accordance with aspects of the present disclosure.

In step 1, a secret parameter of the IoT device 220 is shared with the AIoT controller 210. The secret parameter may be shared between devices (e.g., over the top) or may be based on a pre-configuration between the IoT device 220 and the AIoT controller 210).

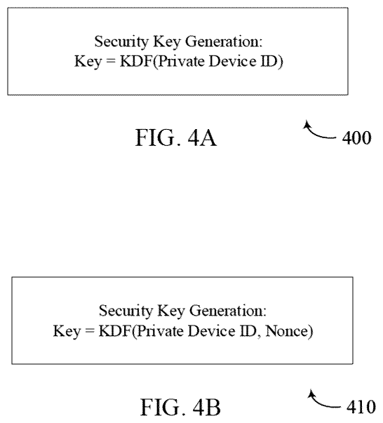

In step 2, the AIoT controller 210 generates a nonce value, which may be a random number or any string of a specific predefined length (e.g., 64 bits). The AIoT controller 210 generates a security key, based on the secret parameters and/or a private device ID for the IoT device 220, using a variety of mechanisms. FIGS. 4A-4B illustrate example key generation representations in accordance with aspects of the present disclosure.

As depicted in FIG. 4A, the AIoT controller 210 may utilize a first mechanism 400 where the secret parameter or private device ID is input into a Key Derivation Function (KDF). Optionally, a length of the secret parameter, such as when the secret parameter has a variable length, may also be input to the KDF.

As depicted in FIG. 4B, the AIoT controller 210 may utilize a second mechanism 410 where the secret parameter/private device ID and a nonce is input into the KDF. Optionally, a length of the secret parameter, such as when the secret parameter has a variable length, may also be input to the KDF. In some cases, use of the nonce facilitates a change of the security key upon every new generation of the key, protecting the command message from possible replay attacks. In some cases, the AIoT controller 210 may utilize other mechanisms, such as simply using the secret parameter as the security key.

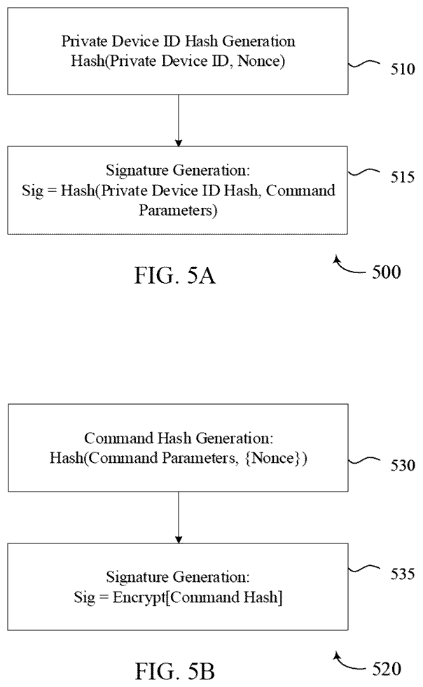

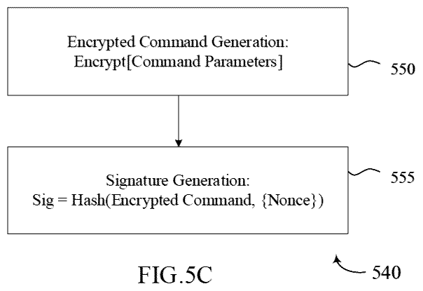

Using the generated security key, the AIoT controller 210 generates a signature, using the command parameters (e.g., disable for a time period or interval) as input into a signature generation mechanism. In some cases, the signature protects the command parameters, and not the command, which may be part of a limited set of commands that are known to the public (e.g., enable or disable operation are known commands or actions/operations performed by devices). FIGS. 5A-5C illustrate example signature generation representations in accordance with aspects of the present disclosure.

As depicted in FIG. 5A, the AIoT controller 210 may utilize a first mechanism 500 that does not employ a security key. First, the AIoT controller 210 generates a first hash 510 of the secret parameter/private device ID and the nonce. Second, the AIoT controller 210 generates a second hash 515 of the first hash 510 and the command parameters, where the second hash 515 is the generated signature (and thus can only be verified by devices having knowledge of the secret parameter).

As depicted in FIG. 5B, the AIoT controller 210 may utilize a second mechanism 520 that employs key generation. First, the AIoT controller 210 generates a hash 530 using the command parameters, and optionally a nonce (when a nonce is not used during key generation), as input. Second, the AIoT controller 210 encrypts 535 the hash 530 with the security key to generate the signature.

As depicted in FIG. 5C, the AIoT controller 210 may utilize a third mechanism 540 that also employs key generation. First, the AIoT controller 210 encrypts 550 the command parameters with the security key. Second, the AIoT controller 210 computes a hash 555 over the encrypted command parameters to generate the signature. In some cases, such as when key generation does not include a nonce, the AIoT controller 210 may additionally compute the hash 555 using the nonce and the encrypted command parameters, using the nonce as a freshness parameter.

Referring back to FIG. 3, The AIoT controller 210, in step 3, sends the command to the IoT device 220. The command may be part of a command request message, which contains the command, command parameters, the nonce, and/or the generated signature. In some cases, such as when a security key is generated for the signature, the command parameters are encrypted with the security key.

In step 4, the IoT device 220 performs a signature generation process, such as in a similar fashion to the AIoT controller 210 (e.g., using the mechanisms described herein). For example, the IoT device 220 generates a security key and generates the signature using the nonce and the command parameters. In some cases, such as when as security key is generated for the signature, the IoT device 220 may first decrypt the command parameters, and then generate the signature.

In step 5, the IoT device 220 verifies whether the generated signature matches the signature received via the command request message (e.g., generated by the AIoT controller 210). When the signatures match, the IoT device 220 determines the message was transmitted by the AIoT controller 210 (e.g., the IoT device 220 trusts the command parameters within the message).

In step 6, the IoT device 220 executes the command based on the command parameters. For example, upon a successful verification of the generated signature, the IoT device 220 performs an action based on the command parameters. Example actions include read operations, write operations, control operations, enable operations, disable operations, and so on.

Optionally, in step 7 the IoT device 220 transmits an acknowledgement (ACK) message to the AIoT controller 210. For example, when the command is a permanent disabling of the IoT device 220, the IoT device 220 may not transmit the ACK and instead perform the disable operation.

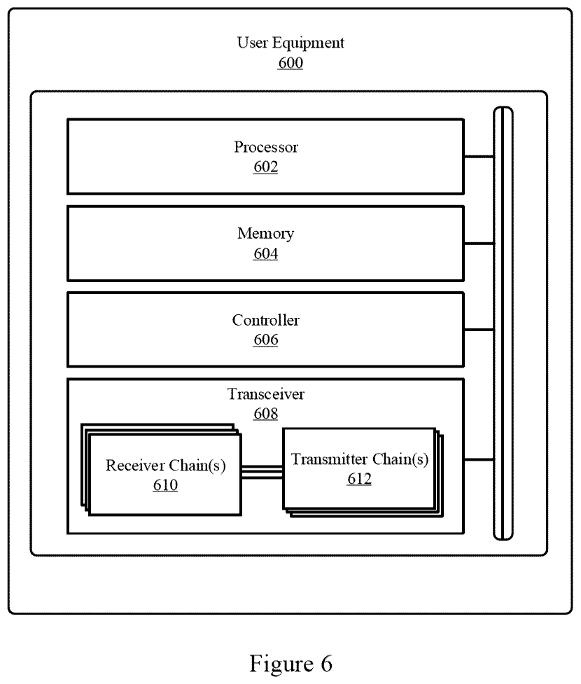

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving a command request message that comprises a nonce, a command, and a signature, generating a security key based on a secret parameter and the nonce, generating a signature using the generated security key and the command as input parameters, comparing the signature of the command request message to the generated signature, and performing an action in response to the command of the command request message when the comparison determines a match of the generated signature to the signature of the command request message.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

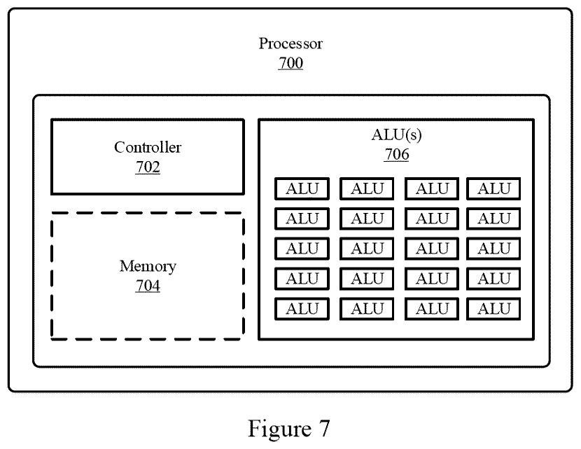

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for receiving a command request message that comprises a nonce, a command, and a signature, generating a security key based on a secret parameter and the nonce, generating a signature using the generated security key and the command as input parameters, comparing the signature of the command request message to the generated signature, and performing an action in response to the command of the command request message when the comparison determines a match of the generated signature to the signature of the command request message.

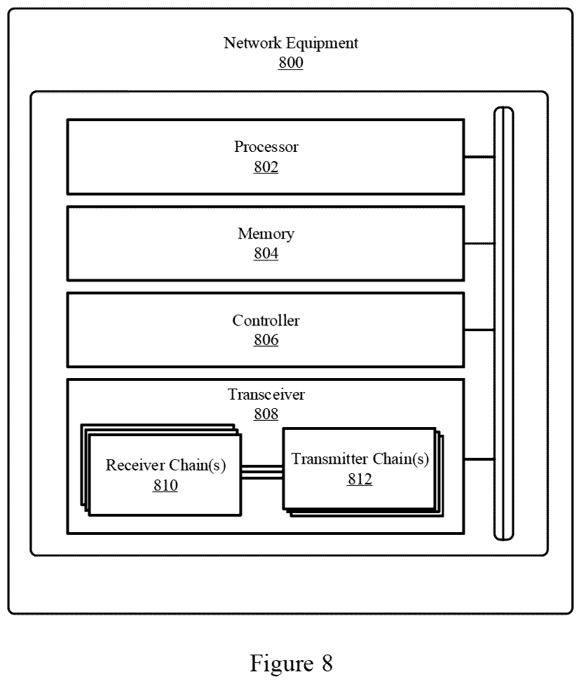

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting a command request message to an AIoT device that comprises a nonce, a command represented by command parameters, and a signature, and receiving a response message from the AIoT device that comprises an acknowledgement of the command request message.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

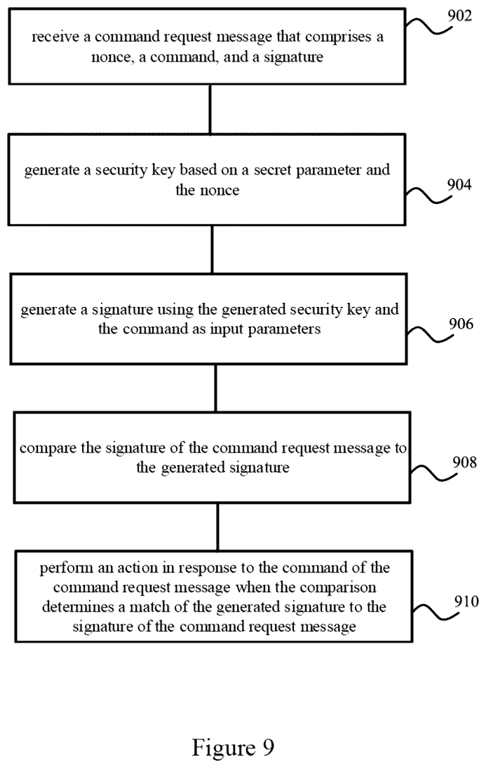

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions.

At 902, the method may include receiving a command request message that comprises a nonce, a command, and a signature. The operations of 902 may be performed in accordance with examples as described herein. In some implementations, aspects of the operations of 902 may be performed by a UE as described with reference to FIG. 6.

At 904, the method may include generating a security key based on a secret parameter and the nonce. The operations of 904 may be performed in accordance with examples as described herein. In some implementations, aspects of the operations of 904 may be performed a UE as described with reference to FIG. 6.

At 906, the method may include generating a signature using the generated security key and the command as input parameters. The operations of 906 may be performed in accordance with examples as described herein. In some implementations, aspects of the operations of 906 may be performed a UE as described with reference to FIG. 6.

At 908, the method may include comparing the signature of the command request message to the generated signature. The operations of 908 may be performed in accordance with examples as described herein. In some implementations, aspects of the operations of 908 may be performed a UE as described with reference to FIG. 6.

At 910, the method may include performing an action in response to the command of the command request message when the comparison determines a match of the generated signature to the signature of the command request message. The operations of 910 may be performed in accordance with examples as described herein. In some implementations, aspects of the operations of 910 may be performed a UE as described with reference to FIG. 6.

It should be noted that the method described herein describes a possible implementation, and that the operations and the steps may be rearranged or otherwise modified and that other implementations are possible.

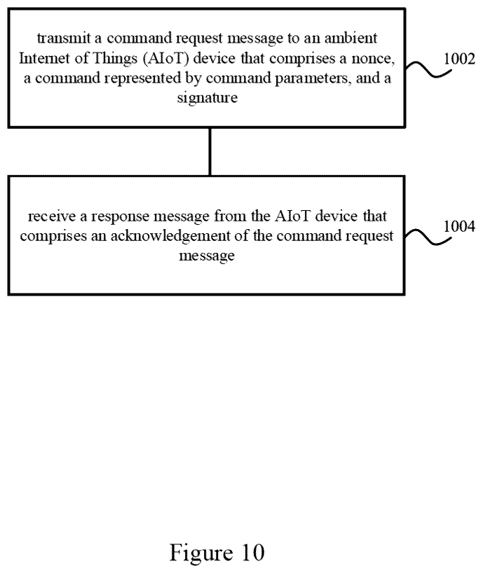

FIG. 10 illustrates a flowchart of a method 1000 in accordance with aspects of the present disclosure. The operations of the method may be implemented by a NE as described herein. In some implementations, the NE may execute a set of instructions to control the function elements of the NE to perform the described functions.

At 1002, the method may include transmitting a command request message to an AIoT device that comprises a nonce, a command represented by command parameters, and a signature. The operations of 1002 may be performed in accordance with examples as described herein. In some implementations, aspects of the operations of 1002 may be performed by a NE as described with reference to FIG. 8.

At 1004, the method may include receiving a response message from the AIoT device that comprises an acknowledgement of the command request message. The operations of 1004 may be performed in accordance with examples as described herein. In some implementations, aspects of the operations of 1004 may be performed by a NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
receive a command request message that comprises a nonce, a command, and a signature;
generate a security key based on a secret parameter and the nonce;
generate a signature using the generated security key and the command as input parameters;
compare the signature of the command request message to the generated signature; and
perform an action in response to the command of the command request message when the comparison determines a match of the generated signature to the signature of the command request message.

2. The UE of claim 1, wherein the command comprises command parameters and the UE performs the action by executing the command parameters.

3. The UE of claim 1, wherein the at least one processor is configured to cause the UE to generate the signature using a hash function and an encryption function.

4. The UE of claim 1, wherein the at least one processor is further configured to cause the UE to:
transmit a response message to a network function after performing the action.

5. The UE of claim 1, wherein the UE is an ambient Internet of Things (AIoT) device.

6. The UE of claim 1, wherein the command comprises a control, read, or write operation to be performed by the UE; and wherein the UE performs the action by performing the control, read, or write operation.

7. The UE of claim 1, wherein the command comprises an enable or disable operation to be performed by the UE; and wherein the UE performs the action by performing the enable or disable operation.

8. A processor for wireless communication, comprising:
at least one controller coupled with at least one memory and configured to cause the processor to:
receive a command request message that comprises a nonce, a command, and a signature;
generate a security key based on a secret parameter and the nonce;
generate a signature using the generated security key and the command as input parameters;
compare the signature of the command request message to the generated signature; and
perform an action in response to the command of the command request message when the comparison determines a match of the generated signature to the signature of the command request message.

9. The processor of claim 8, wherein the command comprises command parameters and the processor performs the action by executing the command parameters.

10. The processor of claim 8, wherein the at least one controller is configured to cause the processor to generate the signature using a hash function and an encryption function.

11. The processor of claim 8, wherein the at least one controller is further configured to cause the processor to:
transmit a response message to a network function after performing the action.

12. The processor of claim 8, wherein the processor is an ambient Internet of Things (AIoT) device.

13. The processor of claim 8, wherein the command comprises a control, read, or write operation to be performed by the processor; and wherein the processor performs the action by performing the control, read, or write operation.

14. The processor of claim 8, wherein the command comprises an enable or disable operation to be performed by the processor; and wherein the processor performs the action by performing the enable or disable operation.

15. A method performed by a user equipment (UE), the method comprising:
receiving a command request message that comprises a nonce, a command, and a signature;
generating a security key based on a secret parameter and the nonce;
generating a signature using the generated security key and the command as input parameters;
comparing the signature of the command request message to the generated signature; and
performing an action in response to the command of the command request message when the comparison determines a match of the generated signature to the signature of the command request message.

16. The method of claim 15, wherein the command comprises command parameters and the UE performs the action by executing the command parameters.

17. The method of claim 15, wherein the UE generates the signature using a hash function and an encryption function.

18. The method of claim 15, further comprising:
transmitting a response message to a network function after performing the action.

19. A network function, comprising:
at least one memory; and
at least one processor coupled with the at least one memory and configured to cause the network function to:
transmit a command request message to an ambient Internet of Things (AIoT) device that comprises a nonce, a command represented by command parameters, and a signature;
receive a response message from the AIoT device that comprises an acknowledgement of the command request message.

20. The network function of claim 19, wherein the at least one processor is further configured to:
generate a security key for the signature; and
encrypt the command parameters using the generated security key.
